(19) United States
(12) Patent Application Publication
(10) Pub. No.: US 2016/0293138 A1
(43) Pub. Date: Oct. 6, 2016

(54) IMAGE PROCESSING METHOD, IMAGE PROCESSING APPARATUS AND DISPLAY DEVICE

(71) Applicant: BOE TECHNOLOGY GROUP CO., LTD., Beijing (CN)

(72) Inventor: Xiao ZHANG, Beijing (CN)

(73) Assignee: BOE Technology Group Co., Ltd., Beijing (CN)

(21) Appl. No.: 14/777,851

(22) PCT Filed: Apr. 20, 2015
(86) PCT No.: PCT/CN2015/076938

§ 371 Date: Sep. 17, 2015

(30) Foreign Application Priority Data
Oct. 11, 2014 (CN) 201410534853.3

(51) Int. Cl. G09G 5/02; G06K 9/62; G06T 5/00; G06K 9/46

(52) U.S. Cl. CPC G09G 5/02; G06K 9/4652; G06K 9/6201; G06T 5/00; G06T 2207/10024; G09G 2320/0626; G09G 2320/0666; G09G 2320/066; G06T 2207/20048

(57) ABSTRACT

The present invention provides an image processing method, an image processing apparatus and a display device. The image processing method includes identifying a plurality of scenarios from an original image, determining an enhancement method corresponding to each of the scenarios, and performing image processing on the corresponding scenario through the enhancement method to obtain an enhanced image. According to the features of different scenarios, different image processing methods are pointedly adopted to enable the processed image to better conform to the cognition of human eyes on the image, so as to achieve an optimal image display effect.

### FIELD OF THE INVENTION

The present invention relates to the field of display technology, and particularly relates to an image processing method, an image processing apparatus and a display device.

### BACKGROUND OF THE INVENTION

An image acquisition process may be affected by such factors as the size of a dynamic range of an imaging device, ambient light intensity and the like, resulting in such phenomena of an image as lower contrast, inconspicuous image information, color distortion, inadequate target contour or boundary information definition and the like, which brings difficulty to human visual observation and machine analysis and processing, so enhancement processing needs to be carried out on the image.

Image enhancement refers to a processing method in which some information of the image is highlighted according to specific demands, and meanwhile some unwanted information is diminished or removed, so as to improve the visual effect of the image and provide an intuitive and clear image which is suitable for analysis. In general, the image enhancement includes contents in three aspects: contrast enhancement, image sharpening and noise filtering. The contrast enhancement is used for improving the visibility of the image and highlighting information hidden due to such reasons as illumination, exposure and the like. The image sharpening is used for improving the clarity of a target object, for example, highlighting the contour or boundary information for detecting and identifying the target object more easily. The noise filtering is used for diminishing noise effect caused in such processes as imaging and transmission, etc.

In the existing image processing method, the brightness and chroma of the image are adjusted in a unified manner to improve the contrast and saturation of the image. However, people cognize an image scenario, and the existing image processing method lacks pertinency, resulting in deviation between the processed image and the cognition of human eyes on the image. Thus, the existing image processing method has limitation for improving the image quality.

### SUMMARY OF THE INVENTION

To solve the above problems, the present invention provides an image processing method, an image processing apparatus and a display device, which are used for solving the problem that the image processing method in the prior art has limitation for improving the image quality due to lacking of pertinency.

To this end, the present invention provides an image processing method, including: identifying at least one scenario from an original image; determining an enhancement method corresponding to the scenario; performing image processing on the corresponding scenario through the enhancement method to obtain an enhanced image.

Optionally, the determining an enhancement method corresponding to the scenario includes: extracting feature information from the scenario; matching the feature information with a feature value in a feature database; if the feature information is successfully matched with the feature value in the feature database, determining the category of the scenario according to the matched feature value; inquiring an enhancement method corresponding to the category of the scenario from an enhancement method database, in order to determine the enhancement method corresponding to the scenario.

Optionally, the step of identifying at least one scenario from an original image includes: converting the original image from a first color space into a second color space, the first color space including three components of a red component, a green component and a blue component, and the second color space including one brightness component and two chroma components.

Optionally, the step of identifying at least one scenario from an original image further includes: dividing the original image into a plurality of scenarios in the second color space.

Optionally, the feature information includes a color feature, a texture feature and a transform domain feature, and the step of extracting feature information from the scenario includes: extracting the color feature from the two chroma components; extracting the texture feature and the transform domain feature from the brightness component.

Optionally, the step of performing image processing on the corresponding scenario through the enhancement method to obtain an enhanced image includes: converting the enhanced image from the second color space into the first color space.

The present invention further provides an image processing apparatus, including: an identifying unit, configured to identify at least one scenario from an original image; a determining unit, configured to determine an enhancement method corresponding to the scenario; a processing unit, configured to perform image processing on the corresponding scenario through the enhancement method to obtain an enhanced image.

Optionally, the determining unit includes an extracting module, configured to extract feature information from the scenario; a matching module, configured to match the feature information with a feature value in a feature database; a determining module configured to, if the feature information is successfully matched with the feature value in the feature database, determine the category of the scenario according to the matched feature value; an inquiring module, configured to inquire an enhancement method corresponding to the category of the scenario from an enhancement method database, in order to determine the enhancement method corresponding to the scenario.

Optionally, the identifying unit includes: a first converting module, configured to convert the original image from a first color space into a second color space, the first color space including three components of a red component, a green component and a blue component, and the second color space including one brightness component and two chroma components.

Optionally, the identifying unit further includes: a dividing module, configured to divide the original image into a plurality of scenarios in the second color space.

Optionally, the feature information includes a color feature, a texture feature and a transform domain feature, and the extracting module includes: a first extracting sub-module, configured to extract the color feature from the two chroma components; a second extracting sub-module, configured to extract the texture feature and the transform domain feature from the brightness component.

Optionally, the processing unit includes: a second converting unit, configured to convert the enhanced image from the second color space into the first color space.

The present invention further provides a display device, including any one of the above-mentioned image processing apparatuses.

### BRIEF DESCRIPTION OF THE DRAWINGS

FIG. 1 is a flowchart of an image processing method in the present invention; and

FIG. 2 is a schematic diagram of a structure of an image processing apparatus in the present invention.

### DETAILED DESCRIPTION OF THE EMBODIMENTS

In order that those skilled in the art can better understand the technical solutions of the present invention, an image processing method, an image processing apparatus and a display device provided by the present invention will be described below in detail in combination with the accompanying drawings.

### First Embodiment

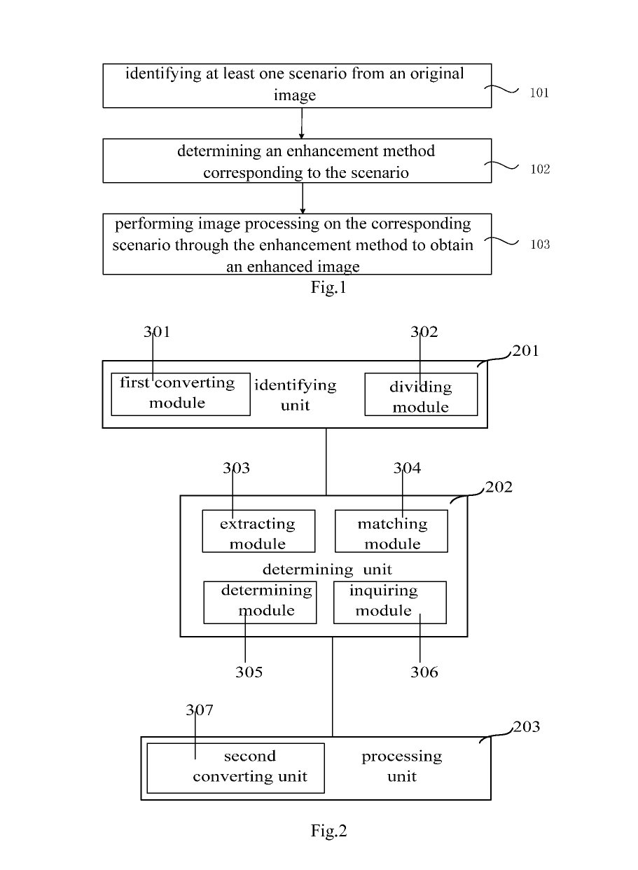

FIG. 1 is a flowchart of an image processing method in the present invention. As shown in FIG. 1, the method includes:

step 101, at least one scenario is identified from an original image.

Optionally, the step 101 includes: converting the original image from a first color space into a second color space, the first color space including three components of a red component, a green component and a blue component, the second color space including one brightness component and two chroma components, the brightness component being used for describing the gray scale information of the image, and the two chroma components being used for describing the color and saturation information. In practical application, image information collected by an image collecting device is information describing various pixel points of the image in the first color space, and in order to avoid loss of the image information in the image processing process, the image can be converted from the first color space into the second color space.

In the embodiment, the original image is divided into a plurality of scenarios in the second color space. One purpose for performing scenario division on the original image in the second color space is to identify different scenarios in the original image. Only when the different scenarios in the original image are identified at first, different image processing methods can be pointedly adopted according to the features of different scenarios to enable the processed image to better conform to the cognition of human eyes on the image, so as to achieve an optimal image display effect. It can be understood that, considering from the perspective of reducing the calculation amount, it is possible to identify only a certain specific scenario, for example, this scenario being one having larger visual impact in a viewing process of the user, and then to enhance the scenario.

Step 102, an enhancement method corresponding to the scenario is determined.

In the embodiment, feature information can be extracted from the scenario, and the feature information may include a color, a shape, a texture and a spatial relationship, wherein the color feature information is mainly extracted from the two chroma components, while the shape feature information, the texture feature information and the spatial relationship feature information are mainly extracted from the brightness component.

Preferably, the feature information includes a color feature, a texture feature and a transform domain feature, the color feature being extracted from the two chroma components, and the texture feature and the transform domain feature being extracted from the brightness component.

In the embodiment, the texture feature includes 7 features:

1) Angular Second Moment

$${f}_{1} = {\sum }_{i = 0}^{L - 1} {\sum }_{j = 0}^{L - 1} {[ p ( i , j ) ]}^{2}$$

the angular second moment expresses a quadratic sum of elements in a grey level co-occurrence, and is also called energy. The angular second moment is used for measuring the uniformity of texture gray scale change of the image to reflect the uniformity coefficient and texture roughness of gray scale distribution of the image, wherein p(i, j) expresses the gray scale of a two-dimensional image at a point (i, j), and the gray scale of the image is generally expressed by 256 levels, L=1,2, . . . , 256

2) Contrast

$${f}_{2} = {\sum }_{i = 0}^{L - 1} {\sum }_{j = 0}^{L - 1} {n}^{2} p ( i , j ) ,$$

n represents a difference between a row position and a column position.

The contrast is used for reflecting the definition of the image and the depth of a texture ditch. The deeper the texture ditch is, the larger the contrast is, the clearer the picture display of the image is; the shallower the texture ditch is, the smaller the contrast is, the fuzzier the picture display of the image is.

3) Correlation

$${f}_{3} = \frac{1}{{σ}_{1} {σ}_{2}} {\sum }_{i = 0}^{L - 1} {\sum }_{j = 0}^{L - 1} ijp ( i , j ) - {u}_{1} {u}_{2}$$

$$wherein$$

$${u}_{1} = {\sum }_{i = 0}^{L - 1} i {\sum }_{j = 0}^{L - 1} p ( i , j ) , {u}_{2} = {\sum }_{i = 0}^{L - 1} j {\sum }_{j = 0}^{L - 1} p ( i , j ) , \\ {σ}_{1}^{2} = {\sum }_{i = 0}^{L - 1} {( i - {u}_{1} )}^{2} {\sum }_{j = 0}^{L - 1} p ( i , j ) , {σ}_{2}^{2} = {\sum }_{i = 0}^{L - 1} {( j - {u}_{2} )}^{2} {\sum }_{j = 0}^{L - 1} p ( i , j ) .$$

4) Entropy

$${f}_{4} = {\sum }_{i = 0}^{L - 1} {\sum }_{j = 0}^{L - 1} \{ p ( i , j ) log p ( i , j ) \}$$

the entropy is a description of the randomness of the textures of the image and reflects the ununiformity degree and complexity of the textures in the image.

5) Variance

$${f}_{5} = {\sum }_{i = 0}^{L - 1} {\sum }_{j = 0}^{L - 1} {( i - u )}^{2} p ( i , j )$$

wherein

$$u = {\sum }_{i = 0}^{L - 1} {\sum }_{j = 0}^{L - 1} p ( i , j )$$

is a mean of p(i, j).

6) Inverse Difference Moment

$${f}_{6} = {\sum }_{i = 0}^{L - 1} {\sum }_{j = 0}^{L - 1} \frac{p ( i , j )}{1 + {( i - j )}^{2}}$$

The inverse difference moment is used for measuring the local texture change of the image, and the larger the numerical value of the inverse difference moment is, the more uniform and the smaller the change of the local textures of the image are.

7) First Average Correlation Information

$${f}_{7} = \frac{HXY - HXY 1}{max \{ HX , HY \}} ,$$

and

Second Average Correlation Information

f₈={1−exp [−0.2(HXY2−HXY)]}^{1/2}

wherein

$$HXY = - {\sum }_{i = 0}^{L - 1} {\sum }_{j = 0}^{L - 1} p ( i , j ) log ( p ( i , j ) )$$

$$HXY 1 = - {\sum }_{i = 0}^{L - 1} {\sum }_{j = 0}^{L - 1} p ( i , j ) log \{ {p}_{x} ( i ) {p}_{y} ( j ) \} ;$$

$$HXY 2 = - {\sum }_{i = 0}^{L - 1} {\sum }_{j = 0}^{L - 1} {p}_{x} ( i ) {p}_{y} ( j ) log \{ {p}_{x} ( i ) {p}_{y} ( j ) \} ;$$

$$HX = {\sum }_{i = 0}^{L - 1} log [ {p}_{x} ( i ) ] , HY = {\sum }_{j = 0}^{L - 1} log [ {p}_{y} ( j ) ] ;$$

$${p}_{x} ( i ) = {\sum }_{j = 0}^{L - 1} p ( i , j ) , {p}_{y} ( j ) = {\sum }_{i = 0}^{L - 1} p ( i , j ) .$$

The above-mentioned 7 specific features of the texture feature are extracted from the brightness component to express the texture feature more accurately, so as to determine the enhancement method corresponding to the scenario more accurately.

In the embodiment, the transform domain feature in the feature information can be extracted from the scenario. The transform domain feature is obtained by Gabor transform. The Gabor transform is developed on the basis of Fourier transform, essentially by adding a window function expressing time to the Fourier transform to provide a time-varying signal of a signal spectrum. When the window function is a Gaussian function, the Fourier transform becomes the Gabor transform. Extracting the transform domain feature from the original image through the Gabor transform is achieved by performing convolution on the original image and a Gabor filter, the Gabor filter including a Gabor sub-band filter, and the Gabor transform including Gabor wavelet transform. When an original image f(x, y) (wherein f(x, y) is a gray value on a pixel position (x, y)) is given, the Gabor wavelet transform of the original image may be expressed as:

wₘₙ(x, y)=f(x, y)*gₘₙ(x, y)

wherein * expresses convolution, gₘₙ(x, y) expresses Gabor sub-band filter group with different scales and different directions, where m represents the series of the scale and n represents the direction. When the scale and the direction are given, a Gabor transform sub-band image of the original image can be obtained. In the embodiment, a filter group composed of 24 Gabor sub-band filters formed by 3 scales and 8 directions is adopted, and the above-mentioned Gabor sub-band filter group can be used for obtaining the transform domain feature composed of 48 feature vectors.

In the embodiment, the feature information is matched with a feature value in a feature database; if the feature information is successfully matched with the feature value in the feature database, the category of the scenario is determined according to the matched feature value; and an enhancement method corresponding to the category of the scenario is inquired from an enhancement method database. The feature database is a database established by the feature values of a plurality of scenarios. The scenario in the embodiment can be divided according to scenery, and includes, for example, sky, water surfaces, plants, white snow, buildings, etc. Of course, in practical application, the scenario can also be divided into other scenarios according to other reference. The enhancement method database is a database established by enhancement methods corresponding to different scenarios. The enhancement method includes such processing methods as contrast enhancement, image denoising, edge sharpening, color enhancement, etc. The enhancement method corresponding to the scenario is used for pointedly processing the image (for example, enhancing the plants by using a color enhancement method, processing the buildings by using an edge sharpening method, and the like), to enable the processed image to better conform to the cognition of human eyes on the image, so as to achieve the optimal image display effect.

Step 103, image processing is performed on the corresponding scenario through the enhancement method to obtain an enhanced image.

In the embodiment, the original image is pointedly processed to obtain the enhanced image. Since a display system generally adopts the first color space, the enhanced image still needs to be converted into the first color space so as to achieve displaying of the image.

In the image processing method provided by the present invention, a plurality of scenarios are identified from the original image, the enhancement method corresponding to each of the scenarios is determined, and image processing is performed on the corresponding scenario through the enhancement method to obtain the enhanced image. According to the features of different scenarios, different image processing methods are pointedly adopted to enable the processed image to better conform to the cognition of human eyes on the image, so as to achieve the optimal image display effect.

### Second Embodiment

FIG. 2 is a schematic diagram of a structure of an image processing apparatus in the present invention. As shown in FIG. 2, the image processing apparatus includes: an identifying unit 201, a determining unit 202 and a processing unit 203. The identifying unit 201 is configured to identify a plurality of scenarios from an original image; the determining unit 202 is configured to determine an enhancement method corresponding to the identified scenario; and the processing unit 203 is configured to perform image processing on the corresponding scenario through the enhancement method to obtain an enhanced image. It can be understood that, considering from the perspective of reducing the calculation amount, it is possible for the identifying unit 201 to only identify a certain specific scenario, for example, this scenario being one having larger visual impact in a viewing process of the user, and then to enhance the scenario.

Optionally, the identifying unit 201 includes a first converting module 301, wherein the first converting module 301 is configured to convert the original image from a first color space into a second color space, the first color space including three components of a red component, a green component and a blue component, and the second color space including one brightness component and two chroma components, the brightness component being used for describing the gray scale information of the image, and the two chroma components being used for describing the color and saturation information. In practical application, image information collected by an image collecting device is information describing various pixel points of the image in the first color space, and in order to avoid loss of the image information in the image processing process, the image may be converted from the first color space into the second color space.

The identifying unit 201 further includes a dividing module 302, and the dividing module 302 is configured to divide the original image into a plurality of scenarios in the second color space. In the embodiment, one purpose for performing scenario division on the original image in the second color space is to identify different scenarios in the original image. Only when different scenarios in the original image are identified at first, different image processing methods can be pointedly adopted according to the features of different scenarios to enable the processed image to better conform to the cognition of human eyes on the image, so as to achieve an optimal image display effect.

The determining unit 202 includes an extracting module 303, a matching module 304, a determining module 305 and an inquiring module 306. The extracting module 303 is configured to extract feature information from the scenario, and the feature information can include a color, a shape, a texture and a spatial relationship, wherein the color feature information is mainly extracted from the two chroma components, while the shape feature information, the texture feature information and the spatial relationship feature information are mainly extracted from the brightness component. Preferably, the feature information includes a color feature, a texture feature and a transform domain feature, the extracting module 303 includes a first extracting sub-module and a second extracting sub-module. The first extracting sub-module is configured to extract the color feature from the two chroma components, and the second extracting sub-module is configured to extract the texture feature and the transform domain feature from the brightness component. For the specific contents of the texture feature and the transform domain feature, reference can be made to descriptions in the above-mentioned first embodiment, and it will not be repeated redundantly herein.

In the embodiment, the matching module 304 is configured to match the feature information with a feature value in a feature database; the determining module 305 is configured to, if the feature information is successfully matched with the feature value in the feature database, determine the category of the scenario according to the matched feature value; and the inquiring module 306 is configured to inquire an enhancement method corresponding to the category of the scenario from an enhancement method database. The feature database is a database established by the feature values of a plurality of scenarios. The scenario in the embodiment can be divided according to scenery, and includes, for example, sky, water surfaces, plants, white snow, buildings, etc. Of course, in practical application, the scenario can also be divided into other scenarios according to other reference. The enhancement method database is a database established by enhancement methods corresponding to different scenarios. The enhancement method includes such processing methods as contrast enhancement, image denoising, edge sharpening, color enhancement, etc. The enhancement method corresponding to the scenario is used for pointedly processing the image to enable the processed image to better conform to the cognition of human eyes on the image, so as to achieve the optimal image display effect.

In the embodiment, the processing unit 203 includes a second converting module 307, and the second converting module 307 is configured to convert the enhanced image from the second color space into the first color space. The original image is pointedly processed to obtain the enhanced image. Since a display system generally adopts the first color space, the enhanced image still needs to be converted into the first color space so as to achieve displaying of the image.

In the image processing apparatus provided by the present invention, a plurality of scenarios are identified from the original image, the enhancement method corresponding to each of the scenarios is determined, and image processing is performed on the corresponding scenario through the enhancement method to obtain the enhanced image. According to the features of different scenarios, different image processing methods are pointedly adopted to enable the processed image to better conform to the cognition of human eyes on the image, so as to achieve the optimal image display effect.

### Third Embodiment

The embodiment provides a display device, including the image processing apparatus provided by the second embodiment, and for specific contents, reference can be made to the description in the second embodiment, and it will not be repeated redundantly herein.

In the display device provided by the present invention, a plurality of scenarios are identified from the original image, the enhancement method corresponding to each of the scenarios is determined, and image processing is performed on the corresponding scenario through the enhancement method to obtain the enhanced image. According to the features of different scenarios, different image processing methods are pointedly adopted to enable the processed image to better conform to the cognition of human eyes on the image, so as to achieve an optimal image display effect.

It can be understood that the foregoing embodiments are merely exemplary embodiments used for illustrating the principle of the present invention, but the present invention is not limited hereto. Those of ordinary skill in the art can make various modifications and improvements without departing from the spirit and essence of the present invention, and these modifications and improvements shall also be encompassed within the protection scope of the present invention.

1-20. (canceled)

21. An image processing method, comprising:
identifying at least one scenario from an original image;
determining an enhancement method corresponding to the scenario;
performing image processing on the corresponding scenario through the enhancement method to obtain an enhanced image.

22. The image processing method of claim 21, wherein the step of determining an enhancement method corresponding to the scenario comprises:
extracting feature information from the scenario;
matching the feature information with a feature value in a feature database;
determining the category of the scenario according to the matched feature value, if the feature information is successfully matched with the feature value in the feature database; and
inquiring an enhancement method corresponding to the category of the scenario from an enhancement method database, in order to determine the enhancement method corresponding to the scenario.

23. The image processing method of claim 21, wherein the step of identifying at least one scenario from an original image comprises:
converting the original image from a first color space into a second color space, the first color space comprising three components of a red component, a green component and a blue component, and the second color space comprising one brightness component and two chroma components.

24. The image processing method of claim 22, wherein the step of identifying at least one scenario from an original image comprises:
converting the original image from a first color space into a second color space, the first color space comprising three components of a red component, a green component and a blue component, and the second color space comprising one brightness component and two chroma components.

25. The image processing method of claim 23, wherein the step of identifying at least one scenario from an original image further comprises:
dividing the original image into a plurality of scenarios in the second color space.

26. The image processing method of claim 24, wherein the step of identifying at least one scenario from an original image further comprises:
dividing the original image into a plurality of scenarios in the second color space.

27. The image processing method of claim 22, wherein the feature information comprises a color feature, a texture feature and a transform domain feature, and the step of extracting feature information from the scenario comprises:
extracting the color feature from the two chroma components; and
extracting the texture feature and the transform domain feature from the brightness component.

28. The image processing method of claim 21, wherein the step of performing image processing on the corresponding scenario through the enhancement method to obtain an enhanced image comprises:
converting the enhanced image from the second color space into the first color space.

29. An image processing apparatus, comprising:
an identifying unit, configured to identify at least one scenario from an original image;
a determining unit, configured to determine an enhancement method corresponding to the scenario; and
a processing unit, configured to perform image processing on the corresponding scenario through the enhancement method to obtain an enhanced image.

30. The image processing apparatus of claim 29, wherein the determining unit comprises:
an extracting module, configured to extract feature information from the scenario;
a matching module, configured to match the feature information with a feature value in a feature database;
a determining module, configured to determine the category of the scenario according to the matched feature value if the feature information is successfully matched with the feature value in the feature database;
an inquiring module, configured to inquire an enhancement method corresponding to the category of the scenario from an enhancement method database, in order to determine the enhancement method corresponding to the scenario.

31. The image processing apparatus of claim 29, wherein the identifying unit comprises:
a first converting module, configured to convert the original image from a first color space into a second color space, the first color space comprising three components of a red component, a green component and a blue component, and the second color space comprising one brightness component and two chroma components.

32. The image processing apparatus of claim 30, wherein the identifying unit comprises:
a first converting module, configured to convert the original image from a first color space into a second color space, the first color space comprising three components of a red component, a green component and a blue component, and the second color space comprising one brightness component and two chroma components.

33. The image processing apparatus of claim 31, wherein the identifying unit further comprises:
a dividing module, configured to divide the original image into a plurality of scenarios in the second color space.

34. The image processing apparatus of claim 32, wherein the identifying unit further comprises:
a dividing module, configured to divide the original image into a plurality of scenarios in the second color space.

35. The image processing apparatus of claim 30, wherein the feature information comprises a color feature, a texture feature and a transform domain feature, and the extracting module comprises:
a first extracting sub-module, configured to extract the color feature from the two chroma components; and
a second extracting sub-module, configured to extract the texture feature and the transform domain feature from the brightness component.

36. The image processing apparatus of claim 31, wherein the processing unit comprises:
a second converting unit, configured to convert the enhanced image from the second color space into the first color space.

37. The image processing apparatus of claim 32, wherein the processing unit comprises:
a second converting unit, configured to convert the enhanced image from the second color space into the first color space.

38. A display device, comprising an image processing apparatus, wherein the image processing apparatus comprises:
an identifying unit, configured to identify at least one scenario from an original image;
a determining unit, configured to determine an enhancement method corresponding to the scenario; and
a processing unit, configured to perform image processing on the corresponding scenario through the enhancement method to obtain an enhanced image.

39. The display device of claim 38, wherein the determining unit comprises:
an extracting module, configured to extract feature information from the scenario;
a matching module, configured to match the feature information with a feature value in a feature database;
a determining module, configured to determine the category of the scenario according to the matched feature value if the feature information is successfully matched with the feature value in the feature database;
an inquiring module, configured to inquire an enhancement method corresponding to the category of the scenario from an enhancement method database, in order to determine the enhancement method corresponding to the scenario.

40. The display device of claim 38, wherein the identifying unit comprises:
a first converting module, configured to convert the original image from a first color space into a second color space, the first color space comprising three components of a red component, a green component and a blue component, and the second color space comprising one brightness component and two chroma components.
